(19) United States
(12) Patent Application Publication
(10) Pub. No.: US 2006/0100925 A1
(43) Pub. Date: May 11, 2006

(54) Demand coupon generating system and method of using same

(76) Inventor: Tom Finaly, Long Beach, CA (US)

Correspondence Address: FULWIDER PATTON LEE & UTECHT, LLP, 200 OCEANGATE, SUITE 1550, LONG BEACH, CA, 90802, US

(21) Appl. No.: 10/985,586

(22) Filed: Nov. 10, 2004

(51) Int. Cl. G06Q 30/00

(52) U.S. Cl. 705/14

(57) ABSTRACT

An on demand coupon generating system for use in a retail setting having a checkout counter and a merchandise display section with products having product identifiers and nearby price displays and including a kiosk with a local processor having access to a searchable database loaded with a listing of product identifiers and at least one unexpired coupon image and an input device to input a customer selected product identifier of a product having a discount available notice displayed near the product or its price tag to compare to the listing in the database and upon finding a match, printing a hard copy coupon of the unexpired coupon image that is instantly redeemable at the checkout stand.

### FIELD OF THE INVENTION

The present invention relates to a discount or coupon generating system, and more particularly, to a system wherein paper coupons may be generated upon demand for immediate use in a retail location.

### BACKGROUND OF THE INVENTION

In recent years, it has been estimated that manufacturers and retailers spent approximately 6.8 billion dollars in order to distribute approximately 336 billion coupons. However, the redemption rate for this amount was significantly lower than expected. For example, of the 336 billion coupons distributed in 2002, consumers only redeemed 3.7 billion coupons or roughly between one to two percent of the total coupons distributed; and this is part of a downward trend for redeeming coupons.

One particular reason for this downward trend is that the customer continues to bear a significant workload in the coupon redemption process. Conventionally, the vast majority of coupons created for a retail setting such as a grocery store or supermarket are supplied once a week as freestanding inserts in a Sunday paper. Such inserts require the customer to peruse the coupon section and cut out coupons relating to items on a personal shopping list or as a target of a possible purchase on a subsequent trip to the grocery store. The customer must then remember to bring the coupons to the store. The coupons are then presented at the checkout stand and the coupon is scanned at the point-of-sale (POS). If the coupon is current and hasn't expired and also matches a particular product the customer wishes to purchase that has also been scanned and thus entered into the checkout computer system, the checkout computer then discounts the purchase price of the product according to the coupon details. This coupon delivery method may require a significant amount of work on the customer's part as each coupon must be reviewed to determine its potential usefulness and then, if selected, must be cut from the newspaper or other printed matter. The customer must also remember to bring the coupons to the store. During the shopping trip, the customer must frequently review the coupons when searching the shelves for the desired item. Moreover, if a significant number of coupons are clipped, the customer must typically organize the coupons as well to save time while shopping. Thus, this method places a significant burden on the customer.

Another reason for the downward trend is that coupons distributed through the Sunday paper are not targeted to a specific customer or group of customers. Existing coupon distribution channels fail because the coupons do not reach the target audience as for example, some consumers do not receive a Sunday newspaper, clipping coupons is a time consuming chore, and the burden is on the customer to remember to bring the coupons to the store. The manufacturer has little control over how many coupons will be redeemed and the coupon is distributed at a location (the consumer's home) away from the point of purchasing decision (the retail store). These characteristics contribute to a lack of coupon redemption.

In addition, from the manufacturer's point of view, introducing coupons through freestanding inserts currently takes about four months with in-store coupons requiring advance notice of six months. This lead time also presents a barrier for the manufacturer to target customers as product popularity may change or not coincide with other corresponding advertising. Tracking the coupon redemption trends also has a time lag in that the redemption effectiveness is gauged by coupon clearing houses and subject to their billing cycles. The effectiveness of the coupon redemption campaign is thus not known for several months and thus cannot be adjusted to on a relatively short timeline. This is another reason targeted campaigns are not mounted successfully.

Another relatively recent concern is the presentation of fake coupons imitating coupons normally distributed in the free standing inserts. Such counterfeit coupons cost the retail industry about 15 billion dollars annually. Thus, control of the coupon distribution process has become more of a concern recently as well. The freestanding insert method does not address this concern adequately.

To address some of the concerns presented by the freestanding inserts coupon distribution method and attempt to increase the likelihood of coupon redemption, manufacturers and retailers have created a variety of incentives to redeem coupons to the prospective customer or otherwise attempt to draw the customer's attention to the availability of the coupon. For example, besides the freestanding insert method, another method of providing coupons to the customer takes place in the retail setting wherein a small plastic housing is mounted to a shelf front that may or may not be near the product indicated on the coupon. Often a red light flashes to alert the customer to the availability of a coupon in the housing. The coupon partially extends out of the housing so that the customer may easily grasp the coupon and pull it from the housing. A replacement coupon, if available, is moved outwardly in the housing to expose a grasping edge. As the housing tends to be relatively low in profile so as not to interfere with the walking space in the aisles, the coupons provided in this manner quickly run out and must be re-supplied frequently. In addition, the coupons do not necessarily pertain to a nearby product. These devices are also generally placed far apart so as not to clutter the aisles and shelves and do not accommodate the distribution of a large number of coupons.

In another manner of providing coupons, a modified shopping cart includes a scanner for scanning the product bar codes of items and may record the coupons on a diskette or print the coupons out of a printer also installed on the shopping cart. Such a method is disclosed in U.S. Pat. No. 5,250,789 to Johnsen. This method, however, is prohibitively costly to install on one cart, let alone every shopping cart in the store, and requires a significant amount of education by the customer. In addition, as carts are often left unattended in parking lots after use by the customers, loss of expensive computer equipment due to theft renders this solution less than desirable.

Another coupon generating system may be found in U.S. Pat. No. 6,691,915 to Thaxton et al. In this patent, an electronic coupon system along with a method for processing electronic coupon cards is disclosed. The coupon system generally includes a coupon card, an in-store kiosk, and a point of sale termina, a host computer, and a coupon data processor. The in-store kiosk includes both a user interface such as a touch screen and a coupon card interface that writes data to the coupon card according to coupon selection data and reads coupon data written upon the card. A point of sale terminal includes a similar coupon card interface. The host computer connects the point of sale terminal with the in-store kiosk. The coupon data processor is programmed to correlate transaction data with coupon data read from the coupon card and to reduce the sale price by an amount indicated by the coupon data. Such systems require the point-of-sale terminal to be modified or reprogrammed to communicate with the host computer and kiosk to discount the price of the goods placed on the coupon card and adds to the overall expense of the system. In addition, the coupon data is primarily stored in a coupon card or computer terminal and thus this system removes any advertising avenue normally provided by a paper coupon.

In U.S. Patent Application Publication No. US 2003/0028426 to Bannerjee et al., another system is described wherein a customer may use a hand-held device employing a scanner and bar code reader to scan a product bar code and display the results on a graphical user interface to transmit scanned product code to a store server. The store server is connected to an e-coupon server with an e-coupon search engine and e-coupon database to retrieve e-coupons related to the scanned product code. The e-coupon is then transmitted to the user's hand-held device. Selected coupons are stored in a store server database that is accessible at a checkout computer when the customer is purchasing the selected products. An e-coupon kiosk may also be used wherein a customer may scan a product code of a selected product to determine if any coupons are available before checkout. If a coupon is available, the customer may elect to store the coupon in his or her personal database that is available to the store server at checkout. As each product is scanned at the checkout counter, it is compared to the stored selected product coupon data. A final tally is completed taking the e-coupons into consideration once all products have been scanned. By relying on e-coupons, this system also removes one avenue of advertising, i.e. the paper coupon. In addition, this system requires the customer become familiar with a completely new system and further requires the customer to review a detailed printout to determine if all coupons were applied correctly.

U.S. Pat. No. 5,918,211 to Sloane requires the customer to checkout a hand held portable scanner at the front of the store prior to shopping from a scanner station and then scan products as they shop. If a scanned product is under promotion, the controller alerts the customer. The scanned product information is sent via wireless transmission to a computer/controller which then sends back the product description and price information to the scanner. The customer is presented with a message indicating an available discount or promotion and allowed the option to purchase the item. A point of sale system is also in communication with the computer/controller. The customer may also elect to print out coupons.

When the consumer has finished shopping, the bar code scanner is returned to the scanning station and the information stored in the scanner is sent to the store's computer and an itemized store receipt is printed. The consumer may then take the receipt to a payment counter and pay for the goods. This type of shopping requires the store owner to rely on the integrity of the customer as he or she does all the scanning instead of the clerk. In effort to protect against theft, a video camera on the bar code scanner and the video signal is then relayed to a central viewing station so that the customer can be watched. This, adds a significant amount of expense to the overall system costs. The introduction of a scanning station capable of providing scanner for each customer in the store also requires a significant amount of floor space that could be used more efficiently. This system also requires a significant amount of new concepts to be learned by the customer.

Another patent requiring the customer to use a hand-held portable scanner may be found in U.S. Pat. No. 6,616,049 to Barkan et al. This system requires the customer to either print out coupons at home and bring them to the store or bring the hand-held scanner to the store and download the coupons at the store. Either alternative requires the customer to remember to bring something from home to the store. Thus, this system does not overcome this customer inconvenience.

What each of these systems has in common is either the removal of a significant avenue of advertising by avoiding the familiar hard copy paper coupon altogether, the continued burden on the customer to remember to bring an item or items from home instead of allowing the customer to perform all steps at the retail setting in order to obtain the rebates, or the requirement of the customer to learn a significantly different system including complex computer skills in order to obtain and track the desired product coupons. Thus, there exists a need for a coupon generating system that exposes customers to an avenue of advertising and maintains familiar concepts, while reducing customer efforts to obtain the benefits of a coupon.

### SUMMARY OF THE INVENTION

In accordance with a preferred embodiment of the present invention a kiosk is provided within the merchandising section in a retail setting prior to the checkout counter and includes an input device for inputting a product identifier of a customer selected product to a local processor that may search a database loaded with a listing of digital product identifiers and at least one unexpired coupon image. Upon finding a match, the local processor transmits a command to a printer to print out a hard copy coupon of the digital coupon image in the database. A discount available notice is displayed in close proximity with the typical price tag location for the products on the shelving in the merchandising area notifying the customer of both a price discount and directing the client to the kiosk to obtain the coupon. The coupon is instantly redeemable at the checkout counter.

In another aspect of the present invention, the product identifier is in the form of a barcode such as a UPC code and the input device is a barcode scanner.

Another feature of the present invention is the inclusion of a display device in the kiosk for displaying instructions or messages to the customer as the kiosk is being used in addition to displaying an image of the coupon being printed or to be printed.

Another aspect of the invention includes the local processor in the kiosk in communication with a remote coupon server administered by a coupon administrator and including a master coupon database and a coupon imager such that coupons received from the manufacturer or retailer may be scanned into coupon server and loaded into the master coupon database. The master coupon database is accessible by the local processor and is responsive to the customer scanning a product identifier at the input device to transmit an unexpired coupon image to the local processor for printing at the kiosk.

In an alternative embodiment of the present invention, the on demand coupon generating system includes a data log for recording a listing of all coupons printed out by the printer in real time for providing a report to a manufacturer, retailer, or coupon administrator.

A method for generating coupons on demand is also disclosed herein.

Other aspects of the present invention will become apparent with further reference to the following drawings and specification.

### BRIEF DESCRIPTION OF THE DRAWINGS

FIG. 1 is a schematic block diagram of an exemplary retail setting in which the on demand coupon generating system according to the present invention may be located;

FIG. 2 is close-up sectional view of a shelf displaying exemplary products in a retail setting such as that schematically illustrated in FIG. 1;

FIG. 3 is a view of an exemplary kiosk incorporated in the on demand coupon generating system according to the present invention;

FIG. 4 is a schematic block diagram of the on demand coupon generating system in accordance with the present invention;

FIG. 5 is a view of an exemplary coupon that may be used in the on demand coupon generating system of FIG. 3;

FIG. 6 is a representative exemplary listing of product identifiers and associated coupon images stored in an exemplary database; and

FIG. 7 is a process diagram illustrating the steps for obtaining a coupon from a kiosk used in the present invention.

### DETAILED DESCRIPTION OF THE INVENTION

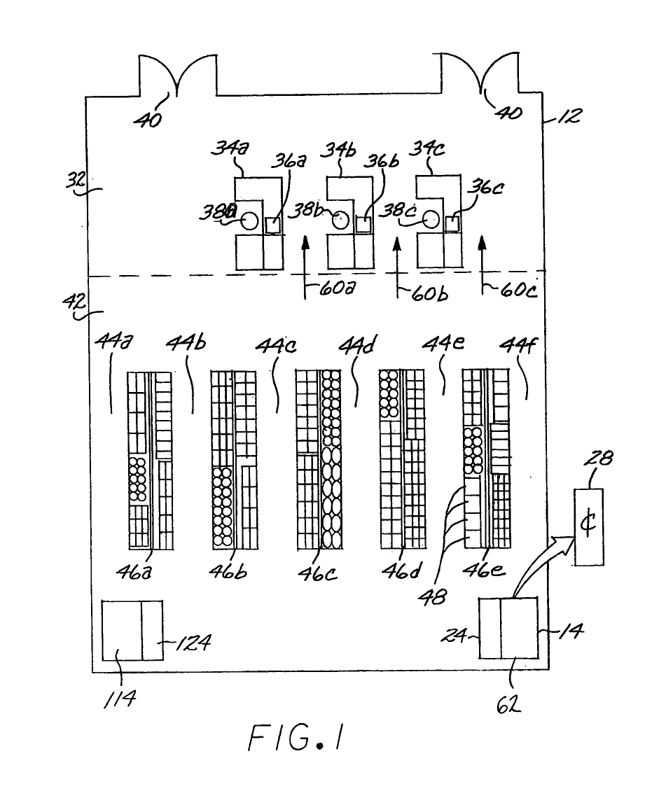

Referring now to FIGS. 1, 2, 4, and 6, an on demand coupon generating system, generally designated 10, in accordance with a preferred embodiment of the present invention is illustrated for use in conjunction with a retail sales location 12 such as a grocery store, consumer goods retail store and the like. In general terms, the on demand coupon generating system includes at least one kiosk 14 located inside the retail store and having a local processor 16 in communication with a database 18 having a listing of product identifiers 20 and associated unexpired coupon images 22, an input device 24 for submitting selected product identifiers to the local processor to compare with the product identifiers in the database and a printer 26 to print out hard copy coupons 28 of the coupon images when a match is found. A discount available notice 30 displayed near the price tag of the products presented to a customer directs the customer to the kiosk to collect the coupon.

The retail setting 12 is which the present invention may be located typically includes a checkout counter region 32 having a plurality of checkout stands. In the FIG. 1 exemplary retail setting 12 there are three checkout stands 34a, 34b, 34c with conventional scanning systems 36a, 36b, 36c and managed by a checkout attendant 38a, 38b, 38c. The checkout counter region generally includes an entry area 40 where the carts and baskets are normally stored and separates a merchandising area 42 from the entry area. In this example, the merchandising area includes six aisles 44a, 44b, 44c, 44d, 44e, 44f and five shelving units 46a, 46b, 46c, 46d, 46e for displaying a variety of products, generally designated 48, for selection and purchase by a customer.

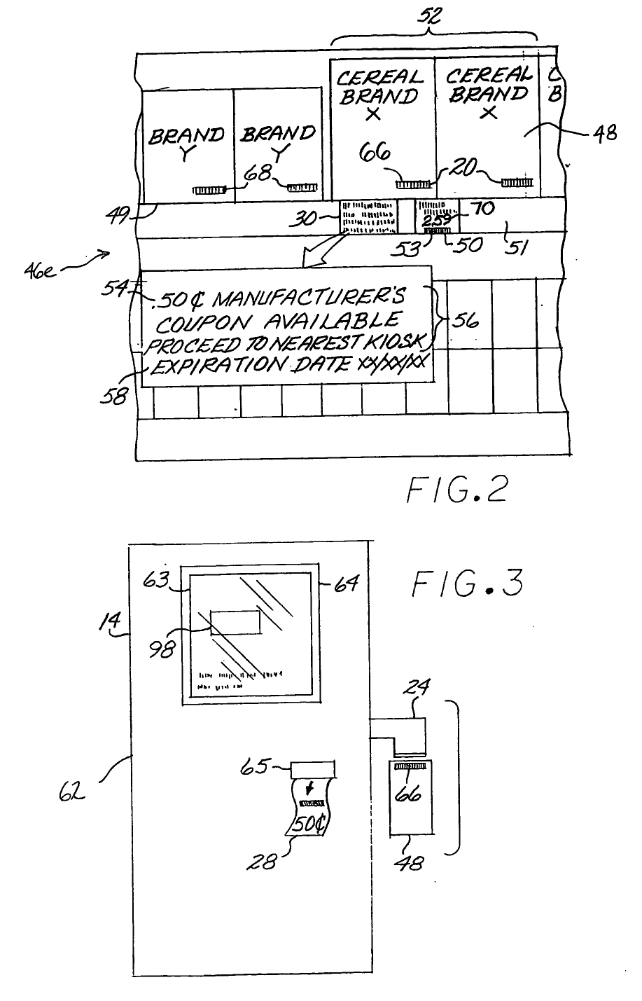

Referring to FIG. 2, the shelving units 46a-e are conventionally constructed with a central divider and several outwardly projecting trays 49 for supporting and displaying the products 48. Sitting atop the trays are a number of products 48 such as the exemplary “Cereal Brand X” illustrated in FIG. 2. In this example, each product 48 includes product identifier 20 in the form of a barcode 66 such as the Universal Product Code (UPC). Barcodes of the same product type are identical. For example, Brand Y goods have a product identifier 20 with a barcode 68 that is unique from that of the barcode 66 of Cereal Brand X.

As illustrated in FIG. 2 each shelf tray 49 includes an outwardly facing display panel 51 wherein a price tag 50 is inserted or adhered beneath a common product area 52. The price tag typically includes a barcode symbol 53 that matches the UPC of the product 48 and a list price 70. The list price is the undiscounted price of the product. Prominently displayed next to the price tag is a discount advertising notice 30. The notice includes the amount of discount 54 to the product list price 70 and an instruction 56 to proceed to a nearby kiosk 14 for a coupon 28. A typical instruction may read “Please proceed to nearest kiosk for coupon”. The notice may also include the expiration date 58 of the coupon offer.

As the customer will typically look for a desired product 48 on the shelf 49 and then look at the price tag 50 to determine the cost of the product, the proximity of the discount available notice 30 practically ensures that the customer's attention will be drawn to the notice. It will be appreciated that amount of the discount displayed right next to the undiscounted price of the product at the point of selection or decision may be strongly persuasive to the customer in selecting that particular product over a nearby similar competing product. It will be appreciated that the notice 30 may incorporate attractive colors or be accompanied by a flashing light or other attention getting device to increase the likelihood of customer consideration. The notice 30 may be directly connected to the price tag, adjacent, or near enough in proximity to likely be viewed as the customer views the price tag. The discount notice may also be integrated into the price tag as well.

Referring back to FIG. 1, in this exemplary retail setting 12 there are two such kiosks, the right hand kiosk as viewed in FIG. 1 being designated 14 and the left hand kiosk being designated 114. These kiosks are located at either end of the merchandising area 42 at or near the end of outer aisles 44f and 44a, respectively. The kiosks are located within the merchandising area so as to be readily available before the customer proceeds to the checkout line 60a, 60b, 60c. The customer may then immediately redeem a coupon 28 during the current shopping trip in contrast to those coupons that are made available at the checkout stand or before the checkout stand and that may only be used on a subsequent trip. It will be appreciated that the kiosks can be made available to the customers at any number of locations within the merchandising area. In addition, any number of kiosks from 1 to N may be used as exemplified in FIG. 4. For example, a kiosk may be located at each end of each aisle, shelf, or at an intermediate location along a shelf for the convenience of the customer.

Referring now to FIGS. 1, 3, and 4, the kiosk 14 includes a housing 62 containing a printer 26, the input device 24, and a display device 64 with a display screen 63. The input device is preferably a barcode scanner such as an NCR7580 available from NCR. It will be appreciated that any conventional input device such as a keypad, keyboard, or optical scanning device may be used to convert the UPC symbol or other barcode 20 on the product 48 to its digital counterpart for processing by the local processor 16. The scanner 24 extends outside the housing 62 providing sufficient room for a customer to place the product identifier 20 of the largest product 48 in the store beneath. Alternatively, the scanner may be of the hand held variety mounted on a hanger (not shown) and wired to the interface of the local processor 16. The display device 64 is a conventional monitor including a display screen 63 provided to display instructions on how to use the kiosk 14 as determined by the programming of the local processor 16.

The printer 26 is a printer of sufficient quality to print out hard copy coupons 28 with bar codes 67 that may be read by the scanners 36a, 36b, or 36c at the respective checkout stands 34a, 34b, 34c. A thermal printer has been found to be satisfactory. The printer is loaded with paper that is standard coupon sized or is pre-cut or perforated in coupon sized increments. This facilitates tearing the coupons out of the paper matrix in which they are delivered. The printer may also cut the paper into an appropriate coupon size. Thus, the coupons 28 may be delivered one at a time or multiple coupons may be printed on the same page but separable. A preferred printer is a Model No. K590 manufactured by NCR. The kiosk 14 includes an output tray 65 of the printer is accessible from the outside of the kiosk housing 62 where customers may pick up hard copies 28 of the selected coupons.

The scanner 24, printer 26, and monitor 64 are powered by a conventional electrical outlet located near the respective kiosks 14, 114 or via a power strip located in the housing 62. The scanner and printer are in communication with the local processor 16 using conventional communication lines or conventional wireless technology. The kiosks 14, 114 may include a convenient servicing door (not shown) so that the coupon paper in the printer 26 may be reloaded or the internal components may otherwise be accessed. The kiosk is preferably placed near a conventional power source such as a store electrical outlet (not shown) to provide power to the printer, processor, scanner, and display screen. The second kiosk 114 is constructed similarly with like components being like numbered with the exception that the second kiosk does not include a local database or data log as explained below.

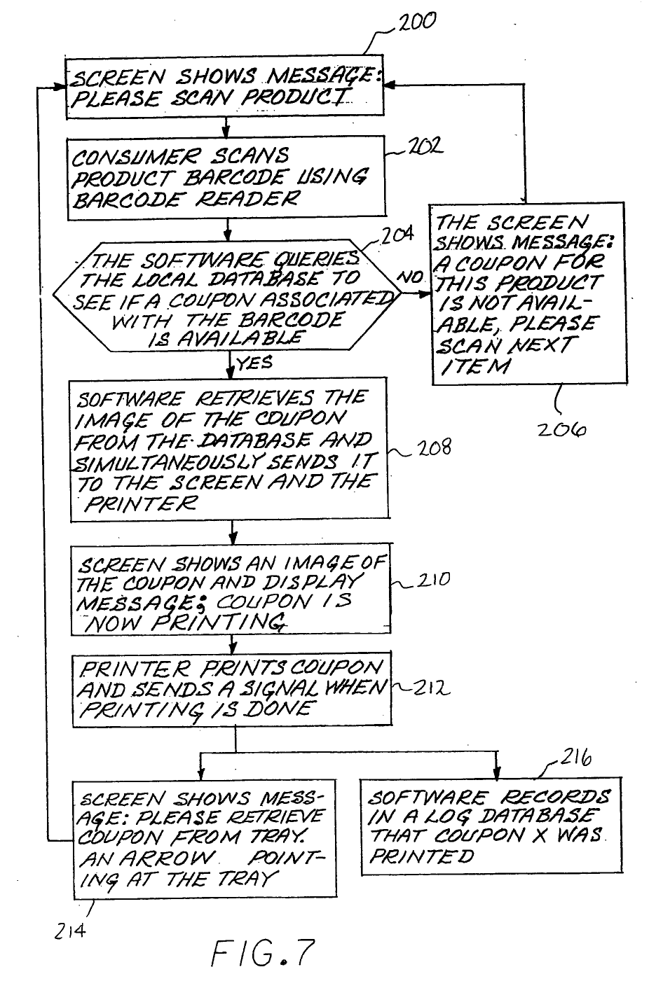

With continued reference to FIG. 4, the kiosk 14 includes a local processor 16 in communication with a local network server 72 via a conventional communication line 74. It will be appreciated that local network server may be physically located either inside or outside of the kiosk. The local server is in turn in communication with a global network line 76 over a second communication line 78. The global network line is typically the Internet. Also in communication with the global network over network line 79 is a central coupon server 80 monitored by the coupon administrator 82. The central coupon server includes a master coupon database 84 with the product identifiers 20 of current coupons and their associated coupon images 22 such as exemplified in FIG. 6. Connectivity software such as eLife, available from eLife, is used to transfer data in either direction over the network lines between the kiosk local 16 processor and central coupon server 80. It will be appreciated that the communication system described herein may occur over a local area network (LAN), wide area network (WAN), or the Internet.

Referring to FIGS. 4 and 6, the master coupon database 84 is structured to store a digital product identifier 120 and an associated coupon image 22 of valid current, unexpired coupons as in the searchable database 18. These coupon images are digital images of physical master coupons 90 provided by various manufacturers 86 and retailers 88 to the coupon administrator 82. The physical master coupons 90 include a price discount 92 and bar code 94 are may be scanned into the on demand system 10 using a coupon imager 96 such as a conventional scanner to create a digital image of the physical coupon which may then be printed out at a remote location such as the kiosk 14, 114 if certain conditions apply. As illustrated in FIG., 6, the master coupon database 84 or a local database 18 may also store the expiration dates 21 of the coupons so that the local processor 16 or coupon server 80 may determine if the coupon is current and useful to the customer when it is scanned and thus may redeemed at that time.

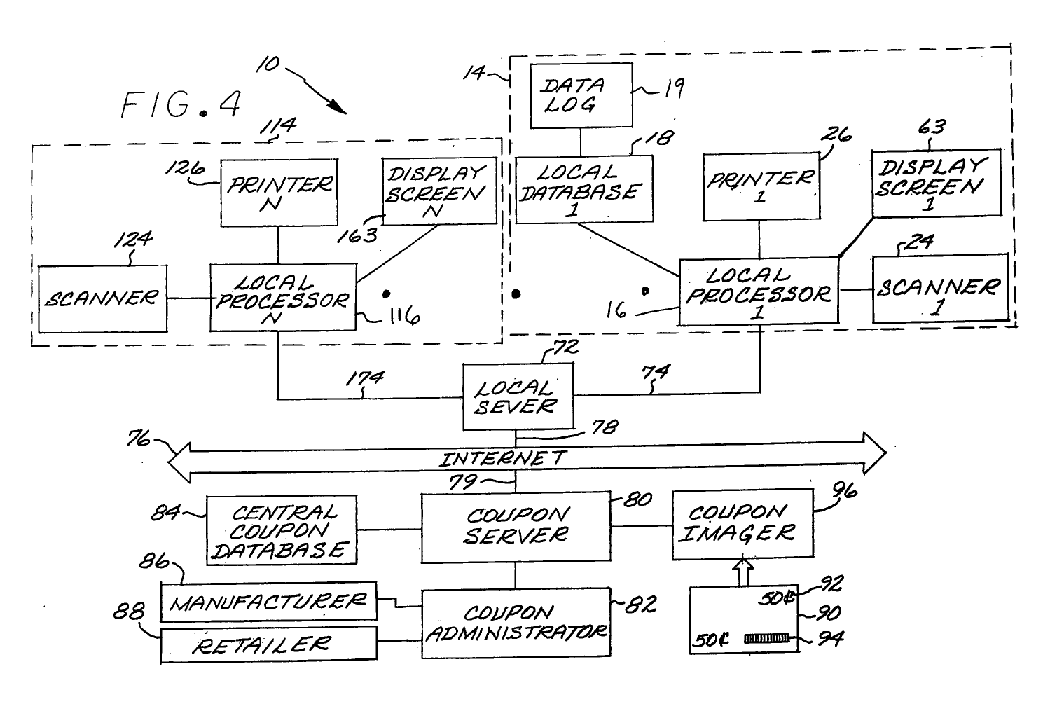

The local database 18 includes a listing of current digital product identifiers 120 associated with current coupon promotions and typically includes a subset in a similar format as the master coupon database. Typically, the local searchable database 18 will only include unexpired coupon images 22 and matching digital product identifiers 120. When the product ID 20 of a particular product 48 is scanned by the customer using the kiosk scanner 24 and converted into a digital product ID 120, the local processor 16 accesses the local database 18 and compares the scanned product ID 120 with the listing of current product identifiers 120 stored in the database and if a match is found, the local processor requests a coupon image 22 corresponding to the matching product ID from the central coupon database 84 over the network 76. Once the digital coupon image 22 is transmitted from the master coupon database 84 to the local processor 16, the digital coupon image 22 is sent to the printer 26 to print out a hard copy of the coupon 28 which is dispensed in the coupon tray 65 of the kiosk 14. At about the same time as the image is sent to the printer, a digital image 98 (FIG. 3) of the coupon 28 is sent to the display screen 63 with a message that “The Coupon is Printing.” Once the printing is complete, a message “Please Retrieve Coupon from Tray” is displayed on the display screen 63.

Referring to FIG. 4, in an alternative embodiment, the kiosk 114 includes a local processor 116, scanner 124, and printer 126 but does not include a local database. The local processor 116 is also in communication with the local server 72 over network line 174 which in turn is in communication with the coupon server 80 over the Internet 76. The local processor is programmed upon receiving a scanned product identifier 120 to route the digital product identifier 120 to the central coupon server 80. The coupon server then accesses and searches the master coupon database 84 for a product identifier listing 120 that matches the scanned product identifier. Once a match is determined, the coupon server 80 transmits the coupon image 22 to the local processor 116 over the network. The local processor 116 transmits a signal to display the coupon image 98 on the display screen 63. At or about the same time, the local processor 116 transmits a signal to the printer 126 to print out a hard copy coupon 28. The printer deposits the coupon in the pick up tray 65 where the customer may simply remove the coupon and place it in his or her cart, basket, or other organizing tool the customer may be using.

Thus, a kiosk 14 with a local database 18 may include both the product identifiers 120 and coupon images 22 and thus issue a matching coupon without further communication from the coupon server 80. The master coupon server may be used to periodically update the local database with coupon listings from the master coupon database. In addition, the local database 18 may solely include digital product identifiers to compare with the scanned in product identifiers 20. Then, if a match is found, a request to the coupon server 80 may be made to transmit a corresponding coupon image 22 stored in the central coupon database 84. If no local database is used such as in kiosk 114, then the local processor 16 access the coupon server 80 to determine if a match is made for each product identifier 20 scanned into the on demand coupon generating system 10.

Each digital product identifier 120 loaded into the database 84 may be associated with more than one coupon image 22 if multiple promotions are offered for example. For example, both the manufacturer 86 and retail store 88 may offer a coupon for the same product. In this case, when the customer scans the product identifier 20 of a product 48 into the scanner 24, both coupons 28 would be displayed on the display screen 63 and then printed out by the printer 26 and issued into the coupon dispensing tray 65. The customer may then take advantage of redeeming both coupons at the checkout counter 34a, 34b, 34c if this does not conflict with the coupon redemption rules.

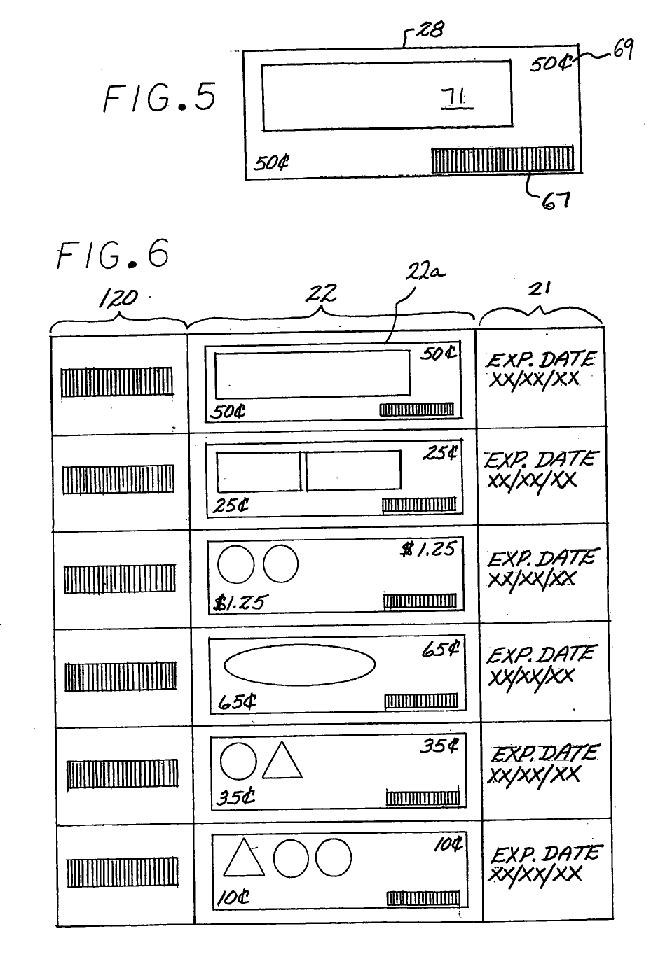

Referring now to FIG. 5, a typical hard copy coupon 28 will include a bar code that is scannable at the checkout stand scanners 36a, 36b, 36c. The hard copy coupon will also include the price discount 69 and will frequently include an advertising area 71 with images of the product or other manufacturer or retailer selected images. An authentication image (not shown) may also be included on the coupon to reduce the likelihood of passing counterfeit coupons. The images of these hard copy coupons are stored in the master coupon database 84 or local database 16 with several exemplary coupon images 22 displayed in FIG. 6. In this example, the first coupon image 22a in FIG. 6 matches the hard copy coupon 28 illustrated in FIG. 5.

In use, the customer will appreciate the convenience in which hard copy coupons 28 may be acquired using the present invention without the necessity of searching through printed matter, clipping coupons for possible use, and then remembering to bring the coupons to the retail center. As most customers are familiar with scanning items and the coupons may be presented and scanned in a conventional manner at the checkout stands, there is very minimal learning curve associated with the present system for the customer and no significant learning curve for the checkout attendants.

With reference to FIGS. 1, 4, and 7, an exemplary procedure for obtaining hard copy coupons 28 using the on demand coupon generating system 10 of the present invention in a grocery store will now be described. This exemplary procedure assumes the local coupon database 16 is pre-loaded with digital coupon identifiers 120, associated coupon images 22, and expiration data 21 as illustrated in FIG. 6. Initially, the customer may enter a retail store 12 incorporating the on demand coupon generating system 10 of the present invention through the entry area 40 and decide whether to use a shopping cart or a basket or some other product carrying apparatus. The customer may then peruse the aisles 44a-f conventionally until he or she comes upon a product 48 of interest, possibly one on his or her shopping list. Posted on the shelf 46e (FIG. 2) is the price 50 of the product, typically provided next to a UPC symbol 53. Typically the price is located directly beneath the product 48 within a slot in the outwardly facing display panel 51f for receiving such price and UPC symbols. In some cases, the price tag 50 is merely a sticker placed on the shelf front facing directly below the product area 52 of a common product.

If a discount coupon is currently being offered by the manufacturer 86, store retailer 88, or other party, for that particular product, a discount advertising notice 30 is displayed prominently next to the price/UPC tag 50. The notice may indicate such information as the discounted price or amount of discount 54 and directions 56 to take the product to the nearest kiosk 14, 114 for scanning to obtain a coupon. Instructions such as “Coupon for $1.25 Available at Kiosk” or “50¢ Manufacturer's Coupon Available Proceed to Nearest Kiosk Expiration Date ______” as shown in FIG. 2 may be used for example. Noting that a coupon is available, the customer may select the product 48 and keep that product in a separate area in the cart although this is not necessary. The customer continues shopping using the same techniques, i.e. looking for the desired products and observing whether any discount available notices 30 are displayed indicating a discount. Sometime during the shopping experience, the customer will spot or otherwise be directed to a kiosk 14, 114 at a convenient location in the store inside the merchandising area 42 and before the checkout stands 34a, 34b, 34c. Typically, the kiosks will be located at the end of at least one of the aisles 44a-f.

Still referring to FIG. 7, upon reaching a kiosk 14, the display screen 63 greets the customer and displays a message to scan a product (step 200). The customer may then present the product identifier 20 on a selected product 48, in this example, a UPC symbol (bar code) that is generally familiar to most customers before the scanner window of the scanning device 24 associated with the kiosk (step 202). The scanner reads the bar code 20 in a conventional manner and transmits a digital version 120 of the product identifier 20 to the primary processor 16. At step 204, the local processor 16 access the local database 18 and compares the listing of acceptable digital product identifiers 120 in the database 18 (FIG. 6) with the product identifier signal transmitted by the scanner 24. If no match is made, then an error message is transmitted to the customer on a display screen 63 in the kiosk (step 206). Alternatively, an audio signal may be issued by the processor signaling an improper scan or a non-matching product. The customer may re-scan the product identifier 20 and a similar comparison will be made by the processor 16. If the same result and the customer is certain that a coupon is available as indicated by a discount advertising notice on the shelf front when the customer obtained the product, the customer may seek out a store assistant to resolve the conflict.

Otherwise, when the local processor 16 finds a match between the product identifier signal and a digital product identifier 120 listing in the database 18, a match signal is generated by the local processor 16 and the processor retrieves the associated coupon image 22 from the database 18 (step 208). An image of the matching coupon is displayed on the display screen 63 along with a message that the coupon is printing (step 210). The digital coupon image 22 is also sent to the printer 26 and a hard copy 28 is printed out for the customer (step 212). Standard coupon sizes may be used to print coupons individually or perforated paper may be used to assist the customer in tearing off the coupon. Alternatively, the coupons may be printed on individual slips of suitable paper or cut with a cutting device before being presented to the customer in the coupon delivery tray 65. The display screen 63 displays a message directing the customer to retrieve the coupon 28 from the tray 65 (step 214). While the coupon is being printed, the data log 19 stores listing of the coupon image or digital product identifier or both (step 216).

The customer may repeat this process (steps 200-216) for each product 48 in the cart and for which a discount advertising notice 30 was displayed. After collecting the desired amount of coupons 28, the customer may proceed to a checkout counter 34a, 34b, or 34c and present the coupons for redemption when purchasing the products 48. The coupons 28 are handled by the checkout clerk 38a, 38b, 38c in a conventional manner. It will be appreciated that by presenting the customer with an actual hard copy coupon 28 as opposed to an e-coupon, the advertising avenue such as the area 71 (FIG. 5) on the coupon is not foreclosed. That is, the customer will typically view the coupon as will the checkout person scanning the coupon and most likely will view the product image as well as any advertising image displayed on the coupon.

Although meant to reduce the time for the customer to scan the products, it will also be appreciated that the customer does not need to keep track of which products 48 are associated with discount notices 30 as the scanner 24, processor 16, and database 18 return a coupon if available. However, the notices 30 may significantly reduce the time the customer must spend at the kiosk 14 if the number of discounted items is relatively few compared to the number of items that do not have discounts.

To initially load the master coupon database 84, the coupon administrator 82 contacts the manufacturers 86 and retailers 88 where the kiosks 14, 114 are located and obtains a sample master coupon 90. These coupons are generally issued well in advance of the effective period. The sample coupons are then scanned into the coupon server 80 using the coupon imager 96 and added as a coupon image 22 to the master coupon database 84. The coupon listing data is then entered including the product identifier 120 and associated with the image 22 for each coupon scanned by the coupon imager 96. This is performed until all the desired coupon images are loaded into the database. The database 84 is then ready to be accessed by the processor 16 in the kiosk. If a local database 16 is used, the unexpired coupon data may be transferred over the communication lines to the local database from the master coupon database for local storage.

To update to the master coupon database 84, the coupon administrator 82 monitors the database on a periodic basis, e.g. daily, to determine if the expiration period of any coupons has been triggered. These listings are deleted from the database 84 so that if a customer scans a product 48, the product identifier 20 of the product will not have a matching digital product identifier listing 120 and thus no coupon will be generated. A retail employee should coincidingly remove any discount advertising notices at the retail location once the expiration period has passed.

For new coupons, the coupon administrator 82 may conveniently upload a new listing in the database 84 along with the new coupon image 22 that are immediately available at the kiosk 14. If the coupon administrator is in communication with the kiosk database 16 over a network such uploading may be performed remotely. Updating the central coupon database 84 renders the coupons available at all kiosks connected to the coupon administrator server over the network. Otherwise, the coupon administrator may make a trip to each retail location and either reprogram the database or insert a replacement database listing using a CD-ROM or the like.

Another feature of the present invention is the use of the data log 19. The data log stores a listing of all product identifiers 120 and coupon images 22 that have been printed along with a time stamp. This listing is immediately accessible and may be transmitted from the coupon administrator to the manufacturers or retailers so they may more closely track the coupon redemption trends.

It will be appreciated that the on demand coupon generating system can be incorporated into a retail setting without requiring the point of sale checkout stand software to be modified in any manner as the coupons printed out at the kiosk can be read by conventional scanners used in such stands. The time to distribute a coupon from the manufacturer or retailer to the customer is also significantly reduced as once the coupon is scanned and loaded into the master coupon database 84, it is ready for immediate redemption by the customer once obtained from the kiosk 14, 114. It will be appreciated that the kiosks may be standalone or networked as described herein. The workload on the customer is minimized because the customer can make a decision to purchase the product at the shelf and then obtain a coupon at a nearby kiosk. The coupons are immediately redeemable. This process avoids forcing the customer to use his or her time to review the Sunday inserts looking for coupons that match a shopping list and paying attention the expiration dates, cut out the coupons, remember to bring the coupons to the market, sort the coupons or keep the coupons in an organizer, shop for items that have coupons that the shopper has brought to the store. Instead, the shopper may merely peruse the shelves for items on a shopping list, view the discount available notice if applicable and decide to select a product at the point of presentation. The customer may then conveniently take the selected products to a nearby kiosk and simply by scanning the bar code of the product, obtain a discount coupon. The coupons which are certain to match the products in the shopper's cart are then presented at the checkout stand in conventional fashion. The discounts are applied to the shopper's totals as the checkout server scans the coupons. There is no need for the shopper to pull coupons brought from home from an organizer at the checkout stand and figure out which products in the cart have coupons.

The kiosk system also reduces the customer workload in that if the customer does not recall which products have discount available notices, the display screen 63 will display a message indicating such if the shopper scans an item not associated with a current discount.

As the coupons are generated in store, this will cut down on the use of counterfeit coupons as well. Additional insignia added only by a licensed kiosk may be imprinted onto the hard copy coupons to prevent customers from bringing in outside coupons as well. In addition, no complicated user shopping smart card is necessary.

While the present invention has been described herein in terms of a number of preferred embodiments, it will be appreciated that various changes and improvements may also be made to the invention without departing from the scope and spirit thereof.

What is claimed is:

1. An on demand coupon generating system for use in a retail location having a checkout counter and a merchandising area displaying a plurality of products bearing product identifiers proximate an associated price tag, said system comprising:
a searchable database having a plurality of digital product identifiers relating to said products displayed in said merchandising area and at least one unexpired coupon image associated with at least one digital product identifier;
an input device operable to convert said product identifier of a product in said merchandising area into a digital product identifier;
a kiosk located in said merchandising area and having a local processor in communication with said input device and said database, said local processor being operable to, upon receiving a digital product identifier from said input device, search said database and issue a print command upon matching said digital product identifier received from said input device with a digital product identifier having an associated unexpired coupon image in said database;
a discount available notice displayed adjacent said associated price tag for at least one said product identifier having an associated unexpired coupon image in said database, said notice including an instruction directing a customer to said kiosk; and
a printer in communication with said local processor and operable to, upon receipt of said print command from said local processor, print out an unexpired hard copy coupon of said associated unexpired coupon image whereby a customer may, upon selecting a product from said merchandising area with a discount available notice, follow said instruction on said notice and transmit a digital product identifier signal to said local processor using said input device to receive an unexpired hard copy coupon for the selected product immediately redeemable at said checkout counter.

2. The on demand coupon generating system as set forth in claim 1 wherein:
said input device is a bar code scanner and said product identifier borne on said products is a barcode.

3. The on demand coupon generating system as set forth in claim 2 wherein:
said barcode is a UPC code.

4. The on demand coupon generating system as set forth in claim 1 wherein:
said searchable database includes an unexpired coupon image for each product having an associated price tag displayed adjacent a discount available notice.

5. The on demand coupon generating system as set forth in claim 1 wherein:
said searchable database is located in said kiosk.

6. The on demand coupon generating system as set forth in claim 1 further including:
a data log in communication with said local processor and operable to record all digital product identifiers associated with all issued print commands to maintain a list of hard copy coupons printed out by said printer.

7. The on demand coupon generating system as set forth in claim 1 wherein:
said kiosk includes a display device in communication with said local processor and operable to display instructions to a customer standing before said display device.

8. The on demand coupon generating system as set forth in claim 1 wherein:
said searchable database is remotely connected to said local processor over a network communication line.

9. The on demand coupon generating system as set forth in claim 1 further including:
a remote central coupon database in communication with said local processor, said remote central coupon database including a master listing of product identifiers and associated unexpired coupon images downloadable to said searchable database for subsequent printing by said printer.

10. The on demand coupon generating system as set forth in claim 9 further including:
an image scanning device operable to scan images of hard copy coupons into said remote central coupon database.

11. The on demand coupon generating system as set forth in claim 8 wherein:
said local processor is in communication with a local server; and
a remote server having a central processor and in communication with said local server over a network communication line, said remote server including a central coupon database storing a master listing of digital product identifiers and associated coupon images.

12. The system as set forth in claim 1 further including:
a central coupon server including a central coupon database;
a local server in communication with at least one kiosk located in a retail setting;
a communication network linking said central coupon server with said local server and operable to transmit coupon related data between said servers.

13. The system as set forth in claim 1 further including:
a central coupon server including a central coupon database programmed to store a listing of product identifiers and corresponding unexpired coupon images;
an image scanner in communication with said central coupon server and operable to convert a paper coupon into a digital coupon image and transmit said digital coupon image to said database for storage.

14. The system as set forth in claim 1 wherein:
said notice is displayed at a product selection point.

15. The system as set forth in claim 1 wherein:
said communication network is a local network.

16. The system as set forth in claim 1 wherein:
said communication network is a global network.

17. An on demand coupon generating system for use in a retail location having a checkout counter and a merchandising area lined with products bearing product identifiers and displayed proximate an advertising price, said system comprising:
a kiosk including a local processor in communication with a local database, said database including a listing of product identifiers with at least one product identifier being associated with an unexpired coupon image;
a scanner in communication with said local processor an operable to transmit a product identifier signal from a product to said local processor;
a printer in communication with said local processor and operable to print out an unexpired coupon upon receipt of a print signal from said local processor; and
said local processor being programmed to receive said product identifier signal from said scanner and compare said product identifier signal to said listing of product identifiers to determine a match, and upon finding a match, transmitting a signal to said printer along with said unexpired coupon image to said printer to print out an unexpired coupon print out.

18. An on demand coupon generating system for use in a retail setting having at least one checkout stand and a merchandising area with rows of products with each type of product having an associated price tag, said system comprising:
a display screen operable to display messages to a customer;
a printer operable to receive a print command and print out a hard copy coupon from a digital coupon image;
a bar code scanner operable to optically scan a product identifier off a product and transmit a product identifier code;
a database including a listing of product identifiers with at least one product identifier including an associated coupon image of an unexpired coupon;
a local processor in communication with said display screen, printer, and bar code scanner, said processor being programmed;
a kiosk housing said display screen, printer, and bar code scanner; and
a discount available notice displayed adjacent at least one said price tag and directing a customer to said kiosk to scan a selected product with said bar code scanner whereby a customer may view said notice and after selecting a product associated with said notice, scan said product identifier into said local processor wherein a hard copy coupon is printed out if a matching digital product listing is found in said local database.

19. An on demand coupon generating system comprising:
means for storing a plurality of product identifier and associated unexpired coupon images;
means of generating a product identifier signal based on a reading of a product identifier on a product and transmitting said product identifier signal;
means for producing a hard copy of said unexpired coupon images;
a coupon generating kiosk operable to receive said product identifier signal and search said means for storing for a match between said product identifier signal among said plurality of product identifier, and upon determining a match, transmit a print signal along with an unexpired coupon to said means for producing a hard copy; and
means for notifying a customer of a coupon availability at said kiosk.

20. A method for generating immediately redeemable coupons on demand in a retail location having a checkout counter and a merchandise display area having a plurality of products to be purchased, said method comprising:
providing a database including a list of current coupons with each coupon listing associated with a particular product identifier;
providing a coupon generating kiosk with a printer and a scanner in communication with said database;
displaying a coupon available notice proximate at least one product in said merchandising display area;
positioning a product identifier of said at least one product before a scanning portion of said scanner;
transmitting said product identifier to said database; and
comparing said scanned product identifier to said list of available coupons in said database and, upon finding a match, transmitting a command signal to said kiosk to print out a coupon for said at least one product.

21. The method for generating coupons in a retail location as set forth in claim 20 further comprising
maintaining a real time log of coupons printed out for redemption by said printer.
